(19) United States
(12) Patent Application Publication
(10) Pub. No.: US 2013/0017755 A1
(43) Pub. Date: Jan. 17, 2013

(54) Shaping of the Sound Channel of a Game Animal Call

(71) Applicant: Jonathan Hudson Hooks, Little Rock, AR (US)

(72) Inventor: Jonathan Hudson Hooks, Little Rock, AR (US)

(21) Appl. No.: 13/547,959

(22) Filed: Jul. 12, 2012

Related U.S. Application Data
(60) Provisional application No. 61/508,498, filed on Jul. 15, 2011.

(51) Int. Cl. A01M 31/00; B23P 17/00

(52) U.S. Cl. 446/207; 29/896.2

(57) ABSTRACT

A call maker typically bores a sound channel from the exhaust port end of the insert through the bell all the way through the insert. A newer innovation was to drill the sound channel to a specific depth in the sound board, but stopping before reaching the tip of the sound board, thus creating back pressure and making the call easier to blow. By drilling the sound channel to just past the seat line, a call maker may then complete the shaping of the sound channel after the forming of the sound board using an end mill to cut a precisely shaped channel with controlled angle, depth, and width to adjust the proper root back pressure and finely tune the call's tone and quality in a replicable manner.

### CROSS-REFERENCE TO RELATED APPLICATIONS

This application claims priority under 35 U.S.C. §119(e) from co-pending U.S. Provisional Patent Application No. 61/508,498, by Jonathan Hudson Hooks, “Cutting out the sound channel of a game call” filed 15 Jul. 2011, which, by this statement, is incorporated herein by reference for all purposes.

### BACKGROUND OF THE INVENTION

Creating a proper game call for a specific application requires the delicate balance of a number of variables. One variable is the root back pressure which is the basic resistance of the air flow through the call, and is largely affected by the sound board and the reed configuration of the insert and their position in the barrel. The root back pressure is then modified by the caller with the use of hands cupped over the bell end of the insert to adjust the final sound of the call.

Traditional calls are made by turning a barrel and drilling the inside to create a hollow cylinder. A tenon is formed on one end of the barrel and a ring is fitted to the tenon encircling the end of the barrel into which the insert is fitted to prevent splitting of the barrel. The distal end from the ring is shaped and smoothed for the user's comfort when used as an in port. Optionally decorative rings markings and features may be added as well as an optional lanyard ring to hold the call conveniently around the hunter's neck.

Next the insert is turned to have a bell on one end and then a taper is formed from the body which will allow the insert to be co axially inserted into the ring end of the barrel up to the seat line. A sound channel is bored along the center axis of the insert from the exhaust port through the portions that is to become the sound board. The wider portion of the taper is formed into the bell, and the distal end is shaped into the sound board. At the base of the sound board, a notch is formed, just before the seat line and a wedge is used with the notch to hold the reed in proper orientation to the soundboard.

### BRIEF DESCRIPTION OF THE DRAWINGS

FIG. 1 illustrates a single reed duck call in accordance with an exemplary embodiment of the invention.

FIG. 2 illustrates an exploded view of a single reed duck call in accordance with an exemplary embodiment of the invention.

FIG. 3 illustrates a perspective view of the insert of a single reed duck call in accordance with an exemplary embodiment of the invention.

FIG. 4 illustrates a cross-sectional view of a single reed duck call with a straight trough in accordance with an exemplary embodiment of the invention.

FIG. 5 illustrates a cross-sectional view of a single reed duck call with an end cap on the trough in accordance with an exemplary embodiment of the invention.

FIG. 6 illustrates an end view of an insert of a single reed duck call with a straight trough in accordance with an exemplary embodiment of the invention.

FIG. 7 illustrates an end view of an insert of a single reed duck call with an end cap on the trough in accordance with an exemplary embodiment of the invention.

### DETAILED DESCRIPTION OF THE PREFERRED EMBODIMENTS

Precisely controlling the shape of the sound channel allows better control of the call's sound. Further, the root back pressure makes the call more controllable by an experienced user such that a wide range of sounds can be achieved in varying situations. Described herein is a method of creating a sound channel for a game call which will allow precise control over the root back pressure of the call, and a method of manufacture of the same in an economical and repeatable manner.

In traditional calls the sound channel is straight, and is created when the insert is bored from the bell end through the tapered body. Next the profile of the sound board is cut along with the notch which allows a cork to secure the base of the reed such that the tip extends over the trough, formed when the top portion of the bored sound channel was removed to create the sound board. In such a call, there is a crescent opening at the tip of the sound board. Such a call is more difficult to use since there is little root back pressure.

To increase the root back pressure, it is desirable that the sound channel is not bored completely through the insert, but instead ends at some point under the reed before the tip of the sound board. This procedure leaves a cap to the sound channel at the tip of the sound board, which produces more back pressure since it forces the air flow to divert up from the channel and turn against the reed before proceeding through the barrel's exhaust port. However, too much back pressure makes a call hard to use, so the trough must be angled above the horizontal to urge the air up and over the cap without creating a vortex in the trough behind the cap.

To properly shape the sound channel one must achieve a smooth transition between the bored portions of the sound channel through the trough and urge the air up against the underside of the reed such that it will continue over the cap at the end of the sound board. Further, by curving the end of the trough behind the cap into a curved spoon-like shape, the concaved end reduces the air vortex which disrupts flow through the call and harshens the sounds produced.

The tone of the call is greatly modified by the shape and size of the trough, and its relationship to the size of the bore. By adjusting the width and the slope of the trough's angled bottom, the sound produced by the call can be adjusted. To achieve such a degree of control over the size and shape of the call's trough, traditional methods of boring from the bell end of the insert are not possible.

The sound board and its trough must be precisely cut to exacting depths to achieve the desired tone in a reproducible manner. By using a jig to hold the insert while cutting the profile of the sound board and the notch, one may control the size and shape of the sound board. Then, by securing the sound board in a jig with the notch above the sound board, and the bore extending to approximately the end of the notch, one may utilize an end mill which has been calibrated to the jig to control the precise depth and shape of the trough. The procedures were described above in the preferred order of the applicant.

By utilizing a computer controlled end mill, the exact dimensions of the trough may be precisely controlled in a repeatable fashion and subsequent calls can be adjusted to achieve the desired characteristics. One skilled in the art would appreciate that some of the steps of shaping, turning, boring, etc. may be performed in differing orders without distracting from the end result and therefore would be applicable to the innovation expressed herein.

The preferred embodiment is a single reed call manufactured out of acrylic with a plastic reed and a rubber cork and aluminum band. One skilled in the art would appreciate that the innovation described herein would be applicable to other reed calls which comprise one or more reeds and troughs in a sound channel. One skilled in the art would appreciate that different materials may be utilized in accordance with the innovation described herein, examples may include, but are not limited to wood, wood composites or plastics for use in the call's body, and Mylar™, latex, plastics, or bamboos for the reeds, and aluminum, stainless steel, copper, or brass for the rings. Further, though the figures below show a single reed duck call, one skilled in the art would appreciate that the innovation may be utilized for producing calls of other animals, including but not limited to ducks, geese, crows, turkeys, hog, deer, rabbit, coyote, etc.

By cutting the sound trough from the vertical alignment, as described herein, the precise shape of the trough, can be controlled on each individual call. Unlike molding where a single mode must be used for hundreds or thousands of calls before the cost of the mold can be economical. Further, the call may be constructed from materials not available for other forms of manufacture. For instance, some acrylics due to their density and hardness are ideal for manufacture of a call, but they cannot be injected or otherwise utilized in the molding process. Wood is ideal for a handcrafted display piece which may be considered by many to have pleasing visual qualities, however wood definitely cannot be molded in the manners necessary to produce the calls described herein.

FIG. 1 illustrates a single reed duck call in accordance with an exemplary embodiment of the invention. From this view the call's (1000), port (1120) opening at the end of the barrel (1100) is where a user would blow to produce the sound. Near the approximate middle of the call (1000) the lanyard ring (1140) is illustrated just to the left of the ring (1110) which encircles the tenon (1130).

To the right of the tenon (1130) the insert (1200) protrudes from the barrel (1100) where the taper (1220) is evident between the seat line (1230, not visible) and the bell (1210) at the far right of the call (1000).

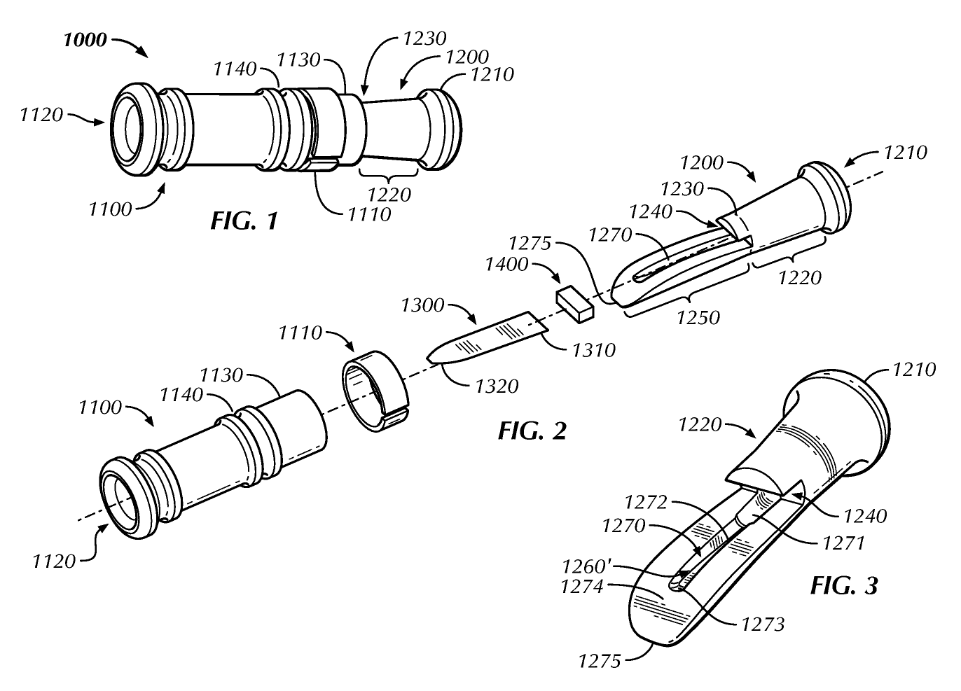

FIG. 2 illustrates an exploded view of a single reed duck call in accordance with an exemplary embodiment of the invention. Here the parts of the barrel (1100) are clearly visible and include the port (1120), the lanyard ring (1140), and the tenon (1130). Here the ring (1110) is separate from the barrel, and is illustrated as a split ring, but one skilled in the art would appreciate that a solid ring is also applicable, and often utilized in construction of animal calls, as discussed above.

The reed (1300) comprises a tip (1320) which would insert first into the barrel during assembly, followed by the base (1310) at the distal end, which is secured with the cork or wedge (1400) to the notch (1240) in the insert (1200) just to the left of the seat line (1230) at the smaller end of the taper (1220). The insert (1200) comprises a sound board (1250), the notch (1240), the taper (1220), and the bell (1210). Through the central axis of the insert (1200) passes the sound channel (1260 and 1260′ not visible). In the embodiment shown, the shaped sound channel (1260′) is illustrated with the tip (1275) shown at the left side of the insert (1200). The trough (1270) is semi-obscured.

FIG. 3 illustrates a perspective view of the insert of a single reed duck call in accordance with an exemplary embodiment of the invention. In this illustration which is shown with the tip (1275) rotated toward the viewer so the portions of the trough (1270) and the rest of the shaped sound channel (1260′) are visible. Working back from the tip (1275) of the sound board, the cap (1274) of the trough has the shaped spoon (1273) which ends the trough (1270). Behind the spoon (1273), the trough (1270) slopes (1272) to the transition (1271) from the trough (1270) near the notch (1240) to the bore (1261, not visible) which continues through the approximate center of the taper (1220) to and through the bell (1210).

FIG. 4 illustrates a cross-sectional view of a single reed duck call with a straight trough in accordance with an exemplary embodiment of the invention. In this cross sectional view the straight sound channel (1260) is clearly visible and comprises the bore (1261) through the bell (1210) and taper (1220) of the insert (1200) through to the transition (1271) to the trough (1270) of the sound board (1250). The top of the trough (1270) is covered by the reed (1300) which is secured at the base (1310) in the notch (1240) by the cork or wedge (1400). The tip (1320) of the reed (1300) suspends above the tip (1275) of the sound board (1250). The entire insert (1200) is inserted into the barrel (1100) from the end distal the port (1120) to the point of the seat line (1230 not indicated).

When a user blows into the call (1000) from the port (1120), the air strikes the tip (1275) of the trough (1270) and goes up to vibrate the reed (1300). As the air passes under the reed (1300), it follows the trough (1270) through the transition (1271) to the bore (1261) and out the bell (1210).

FIG. 5 illustrates a cross-sectional view of a single reed duck call with an end cap on the trough in accordance with an exemplary embodiment of the invention. In this cross sectional view, the shaped sound channel (1260′) is clearly visible and comprises the bore (1261) through the bell (1210) and taper (1220) of the insert (1200), through to the transition (1271), to the trough (1270) of the sound board (1250). The top of the trough (1270) is covered by the reed (1300) which is secured at the base (1310) in the notch (1240) by the cork or wedge (1400). The tip (1320) of the reed (1300) suspends above the tip (1275) of the sound board (1250). The trough which starts with the transition (1271) near the notch (1240) has a slope (1272) which angles above the horizontal to join the spoon (1273) just behind the cap (1274) at the tip (1275) of the sound board. The entire insert (1200) is inserted into the barrel (1100) from the end distal the port (1120) to the point of the seat line (1230 not indicated).

When a user blows into the call (1000) from the port (1120), the air strikes the tip (1275) of the sound board (1250) and goes up to vibrate the reed (1300). As the air passes under the reed (1300), and over the cap (1274), to the spoon (1273) which allows it to flow to the slope (1272) without disturbing vortexes which harshens the sound of the call. The slope (1272) angles the air down the trough (1270) through the transition (1271) to the bore (1261) and out the bell (1210).

The spoon (1273) and the slope (1272) reduce the disturbances of the air flow allowing a smoother, more natural sounding call. This spoon and slope are only achieved in a cut call by precisely shaping the trough (1270) with an end mill or other type of vertical cutting system which approaches the sound board (1250) from the direction of the reed (1300), rather than through the bell (1210) as previously performed. Also, due to the length of the bore (1261), it is impossible to precisely angle the slope (1272) with a rotary cutter without comprising the length of the insert, which would detrimentally alter the tone of the call.

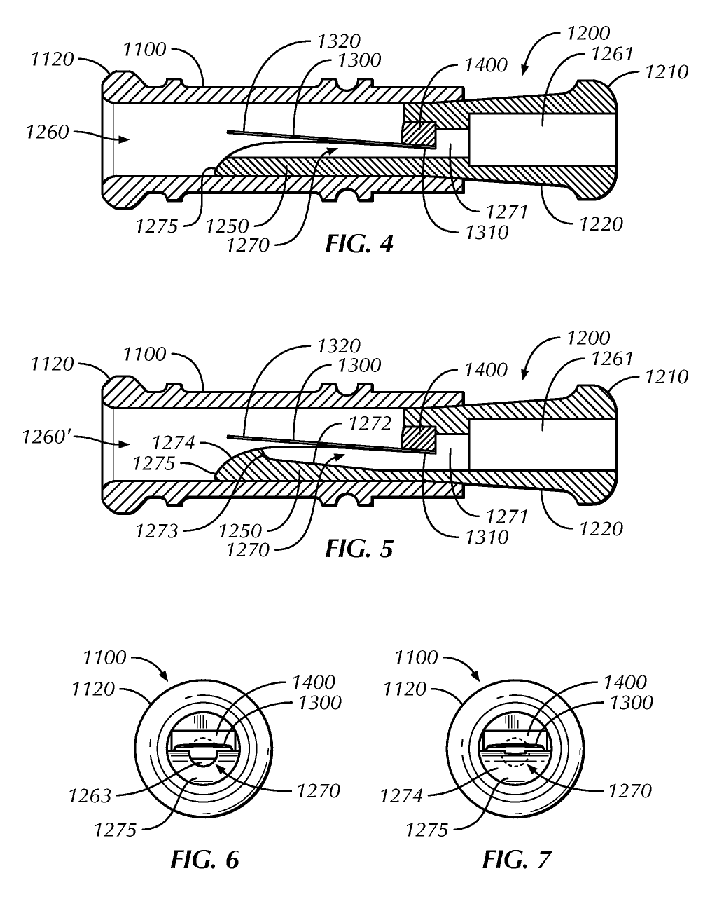

FIG. 6 illustrates an end view of an insert of a single reed duck call with a straight trough in accordance with an exemplary embodiment of the invention. The view is of an insert (1200) viewed from the tip (1275) with the bell (1210) at the distal end. Here the straight trough results in a crescent opening (1263) at the tip (1275) of the sound trough (1270), which is covered by the reed (1300) secured by the cork (1400). This crescent opening (1263) reduces the root back pressure of the call making it harder to blow properly.

FIG. 7 illustrates an end view of an insert of a single reed duck call with an end cap on the trough in accordance with an exemplary embodiment of the invention. The view is of an insert (1200) viewed from the tip (1275) with the bell (1210) at the distal end. Here, the shaped sound channel comprises a cap (1274) at the tip (1275) of the sound trough (1270), which is covered by the reed (1300) secured by the cork (1400). This eliminates the crescent opening (1263, not present) and increases the root back pressure of the call making it easier to blow properly. However, the presence of the cap (1274) makes it impossible to cut the trough (1270) and to precisely angle the slope (1272, not illustrated), unless one approaches with an end mill, or similar vertical cutting apparatus from the reed (1300) side, down into the trough. Further, the use of an end mill allows for precise angling of the side walls, or the non-angling of the side walls to produce a rectangular, semicircular, or other cross-sectional shape to the trough. Further, cross-sectional shape of the trough does not need to be uniform, and may be adjusted to vary the sound of the call at the discretion of the maker.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of shaping the sound channel of a game call comprising:
shaping a tapered insert for the game call,
thus having a large end and a narrow end of the insert;
said narrow end being insertable into an opening in a barrel of the game call to a seat line;
boring an opening, parallel to the center axis, from the large end to approximately the seat line; thus forming an in port;
cutting said insert, parallel to the center axis, from the narrow end to approximately the seat line;
thus forming a sound board having a base and a tip, where said tip corresponds with the narrow end of the insert;
carving a trough along the center axis of the insert from the seat line toward the tip of the sound board.

2. A method, as described in claim 1 wherein the carving the trough comprises:
leaving a cap near the time of the sound board;
carving an end to the trough comprising a spoon behind the cap distal adjacent the cap, distal the tip of the sound board;
angling the base of the trough from the cap down to the bored opening of the in port near the seat line;
transitioning the trough to the bored opening.

3. A method, as described in claim 2 wherein the carving the trough further comprises:
securing the sound board in a jig;
positioning the jig in a vertical drilling device;
utilizing the vertical drilling device to precisely control the shape of the trough;

4. A method, as described in claim 3 wherein the vertical drilling device is a drill press.

5. A method, as described in claim 3 wherein the vertical drilling device is an end mill.

6. A method, as described in claim 2 wherein the vertical drilling device is computer controlled in at least one dimension.

7. A method, as described in claim 2 wherein the vertical drilling device is computer controlled in at least two dimensions.

8. A method, as described in claim 2 wherein the vertical drilling device is computer controlled in at least three dimensions.

9. A method, as described in claim 1 wherein the trough has a rectangular cross sectional shape.

10. A method, as described in claim 1 wherein the trough has a semicircular cross sectional shape.

11. A method, as described in claim 1 wherein the trough has a non-uniform cross sectional shape comprising at least two distinct cross sectional shapes at differing points along the trough.

12. A method, as described in claim 3 wherein carving the trough is performed by a computer controlled milling device programmed to repeatedly perform the carving on a plurality of sound boards.

13. A method, as described in claim 1 wherein the sound board and the taper are formed as independent components and joined after shaping to form the insert.

14. An insert for a game call comprising:
a bell at one end of a tapered body;
the distal end of said tapered body comprising a sound board;
the transition point from the tapered body to the sound board being near a seat line;
the insert further comprising a sound channel passing through the tapered body from the bell, along the approximate mid axis of the insert to the end of the sound board;
the end of the sound channel proximately disposed to the center top of the sound board being a trough;

15. An insert for a game call as described in claim 14 wherein the sound channel comprises:
a substantially cylindrical opening from and through the bell end of the insert to proximately the end of the sound board nearest the seat line;
a transition from cylindrical opening to a trough in the side of the sound board nearest the axial center of the insert;
the trough further comprising a sloping groove angled from the bottom of the cylindrical opening to join a shallower spoon end of said trough near the tip of the sound board.

16. An insert for a game call as described in claim 14 wherein the sound channel is adjusted in depth and thickness to control a back pressure experienced by a call user.

17. An insert for a game call as described in claim 14 wherein the sound channel is adjusted in depth and thickness to alter the tone of the call.

18. An insert for a game call as described in claim 14 wherein the sound channel is adjusted in depth and thickness to alter the experience of a call user.

19. An insert for a game call as described in claim 14 wherein the sound channel is further adjusted in cross-sectional shape to alter the experience of a call user.

20. An insert for a game call as described in claim 14 where the sound channel's cross sectional shape is different in a plurality of points along the length of the channel to alter the experience of a call user.
